(19) United States
(12) Patent Application Publication
(10) Pub. No.: US 2019/0193385 A1
(43) Pub. Date: Jun. 27, 2019

(54) METHOD FOR PRODUCING SHEET MATERIAL, AND METHOD FOR MIXING MIXED RAW MATERIAL

(71) Applicant: KASAI KOGYO CO., LTD., Kanagawa (JP)

(72) Inventors: Yoshiyuki SHIMIZU, Koza-gun, Kanagawa (JP); Hiroshi NIHO, Yokohama-shi, Kanagawa (JP)

(21) Appl. No.: 16/301,110

(22) PCT Filed: Sep. 16, 2016
(86) PCT No.: PCT/JP2016/077576

§ 371 Date: Nov. 13, 2018

(51) Int. Cl. B32B 37/15; B29C 48/07; B32B 27/08

(52) U.S. Cl. CPC B32B 37/153; B29K 2105/26; B32B 27/08; B29C 48/07

(57) ABSTRACT

A method of manufacturing a mixed material includes mixing a first material and a third material containing a second material with each other to obtain a mixed material. The first material contains a recycle material being the mixed material by a recycle ratio of r wt % to the first material. The third material contains the second material by X wt %. In the mixing, a ratio of the third material to the mixed material is set to be [A·X·(100−r)]×10⁻⁶ wt %, where A is a content of the second material to the mixed material by weight percent after the first material and the third material are repeatedly mixed with each other infinitely often.

### CROSS-REFERENCE TO RELATED APPLICATIONS

This application is a National Stage Entry application of PCT International Application No. PCT/JP2016/077576, filed on Sep. 16, 2016, the entire contents of which are hereby incorporated by reference.

### BACKGROUND

### 1. Technical Field

The present invention relates to a method for manufacturing a sheet member and a method for mixing a mixed material.

### 2. Description of the Background

Conventionally, automotive interior parts such as door trims, luggage trims, or rear parcel shelfs are manufactured through the press forming process performed on a sheet member being a composite material, which is a lamination of a sheet base member composed of polypropylene resin or the like and a nonwoven fabric formed of polyester fibers or the like as a surface member (see Japanese Patent Application Publication No. H11-010717 (hereinafter referred to as “Patent literature 1”) and Japanese Patent Application Publication No, 2002-292664 (hereinafter referred to as “Patent Literature 2”)).

In the press forming process and its preceding and subsequent processes, the sheet member is trimmed into a predetermined shape and any openings are punched out of the sheet member. Therefore, waste members are produced in these processes. The ratio of the waste members can reach about 50% in serious cases.

Accordingly, there have been made attempts to recycle (reuse) the waste members. Here, the sheet member is made up of the base member and the surface member composed of different resin materials. Recycling just the base member necessitates a removal or separation work and, consequently, takes much time and costs.

### BRIEF SUMMARY

On the other hand, it has also been contemplated to recycle the sheet member without separating into the base member and the surface member. In this case, waste members produced from a sheet member containing any recycled waste members are again recycled. Therefore, the ratio between the materials of the sheet member (or the base member) changes after every recycling, inviting a loss of a desired physical property.

The present invention has been made in view of such circumstances, and an object thereof is to provide a method for manufacturing a sheet member whose physical property little changes despite use of a composite material being recycled.

Other object of the present invention is to provide a method for manufacturing a mixed material whose physical property little changes despite use of a mixed material being recycled.

The present invention has been made in order to achieve the object stated above. (1) One aspect of the present invention is a method for manufacturing a sheet member having a lamination of a first sheet and a second sheet. The method includes: a first step of extruding, in a sheet-like manner, a first material containing a sheet member as a recycle material, to form a first sheet; and a second step of laminating a second sheet composed of a second material and the first sheet obtained by the extruding. In the first step, the recycle material is mixed into the first material by a recycle ratio of r wt % to the first material. In the second step of laminating the second sheet and the first sheet, a ratio of the second sheet to the sheet member is set to be [A·(100−r)]×10⁻⁴ wt %, where A is a content of the second material to the sheet member by weight percent after the first step and the second step are repeatedly performed infinitely often.

(2) Other aspect of the present invention is a method for manufacturing a mixed material. The method includes mixing a first material and a third material with each other to obtain a mixed material. The first material contains a recycle material being the mixed material by a recycle ratio of r wt % to the first material. The third material contains the second material by X wt %. In the mixing, a ratio of the third material to the mixed material is set to be [A·X·(100−r)]×10⁻⁶ wt %, where A is a content of the second material to the mixed material by weight percent after the first material and the third material are mixed with each other infinitely often.

The present invention provides the method for manufacturing a sheet member whose physical property little changes despite use of a composite material being recycled.

Further, the present invention provides the method for manufacturing a mixed material whose physical property little changes despite use of a mixed material being recycled.

### BRIEF DESCRIPTION OF DRAWINGS

FIG. 1 is a schematic diagram illustrating processes of manufacturing an interior part.

FIG. 2 is a cross-sectional view showing the structure of a sheet member.

FIG. 3 is a schematic diagram illustrating a method for manufacturing a sheet member according to a first embodiment of the present invention.

FIG. 4 is a graph showing the result of evaluating the physical property of the sheet member.

FIG. 5 is a schematic diagram illustrating a method for manufacturing a mixed material according to second embodiment of the present invention.

### DETAILED DESCRIPTION

In the following, with reference to the drawings, a detailed description will be given of modes for carrying out the present invention (hereinafter referred to as “embodiments”).

### Interior Part

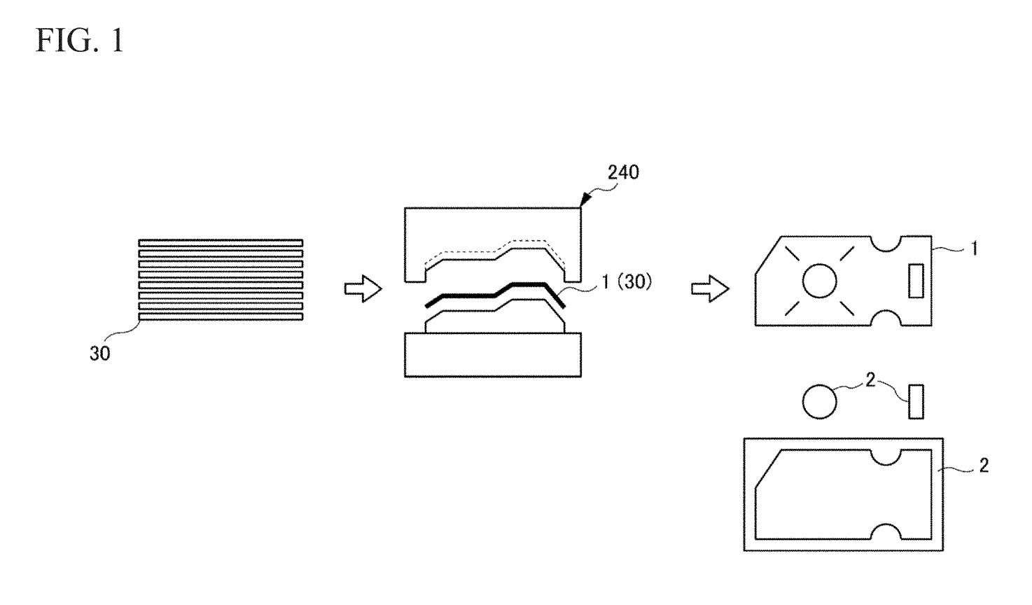

FIG. 1 is a schematic diagram illustrating processes of manufacturing an interior part.

Normally, a vehicle's cabin includes an interior part 1, such as a door trim, a luggage trim, or a rear parcel shelf The interior part 1 is obtained from a sheet member 30 being a lamination of a first sheet 10 and a second sheet 20. The sheet member 30 undergoes works with a press forming machine 240 including a die assembly made up of an upper die and a lower die. Conforming to the shape of the die assembly, the sheet member 30 is shaped into any shape of the interior part 1 including recesses and protrusions, holes or openings.

During, before and after the press forming process with the press forming machine 240, from the original sheet being the sheet member 30, portions that do not serve as the interior part 1 are produced as waste members 2. Recycling (reusing) the waste members 2, a new sheet member 30 is manufactured.

### Sheet Member

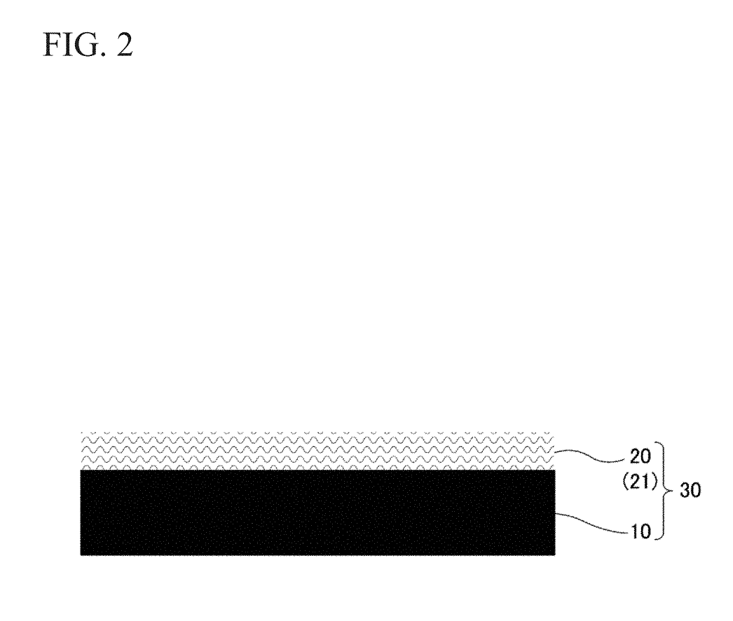

FIG. 2 is a cross-sectional view showing the structure of the sheet member.

The sheet member 30 is a composite material being a lamination of a first sheet 10 as a sheet base member and a second sheet 20 as a surface member, The thickness of the first sheet 10 falls within a range of about 0.5 mm to 6 mm inclusive, and the thickness of the second sheet 20 falls within a range of about 0.5 mm to 2 mm inclusive. Therefore, the thickness of the sheet member 30 falls within a range of about 1 mm to 8 mm inclusive. The lamination ratio by weight between the first sheet 10 and the second sheet 20 will be described later.

The first sheet 10 is formed of a first material 11 extruded sheet-like. The first material LI forming the first sheet 10 is composed of a first component 12 in the initial state, and contains an additive 13 or the like as necessary. When the waste members 2 are to be recycled, the waste members 2 are added to the first material 11 as a recycle material 31.

Here, the first component 12 is, for example, polypropylene (PP) resin. Further, the additive 13 may be talc which facilitates moldability and releasability.

The second sheet 20 is formed as a nonwoven fabric sheet of fibers composed of a second material 21 The second material 21 forming the second sheet 20 is, for example, polyester (polyethylene terephthalate, PET) resin.

### Apparatus and Method for Manufacturing Sheet Member

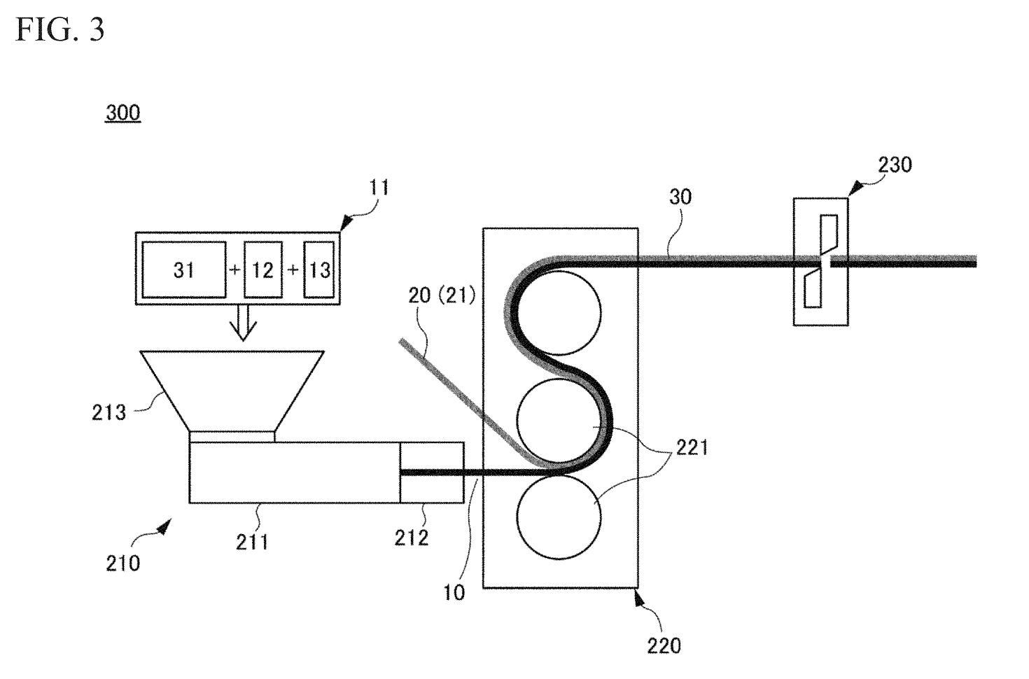

FIG. 3 is a schematic diagram illustrating a method for manufacturing the sheet member of the present embodiment.

A manufacturing apparatus 200 for manufacturing the sheet member 30 includes by an extrusion machine 210, a laminating machine 220, and a cutting machine 230.

The extrusion machine 210 used in a first step S1 of forming the first sheet 10 includes an extrusion barrel 211, and a T-die 212 provided at the exit end of the extrusion barrel 211.

Provided on the extrusion barrel 211 is a supply hopper 213 from which an extrusion material, that is, the first material 11, is supplied. The extrusion barrel 11 includes therein a not-shown screw for extruding the first material 11. Further, the extrusion barrel 211 also includes a not-shown heater for heating and melting the first material 11.

The supplied first material 11 is previously fined into chips or pellets and shuffled. When the first material 11 contains the waste members 2 of the sheet member 30 as the recycle material 31 also, the first material 11 is similarly fined and shuffled.

The T-die 212 spreads the first material 11 extruded from the extrusion barrel 211 in the width direction thereby shaping the first material 11 sheet-like, and discharges the shaped first material 11 from a slit. In this manner, the extrusion machine 210 extrudes the first material 11 sheet-like, thereby forming the first sheet 10.

Next, a laminating machine 220 used in a second step S2 of laminating the first sheet 10 and the second sheet 20 together includes a pair of laminating rollers 221.

The laminating machine 220 sets the first sheet 10 and the second sheet 20 between the pair of laminating rollers 221 and produces a laminate consisting of the first sheet 10 and the second sheet 20. Note that, the laminating rollers 221 are not limited to an upper and lower pair, and may be a set of three rollers consisting of an upper roller, an intermediate roller, and a lower roller. In this case, the first sheet 10 is set between the intermediate and lower laminating rollers d the second sheet 20 is fed between the upper and intermediate laminating rollers 221 from the right side in the drawing so that the first sheet 10 and the second sheet 20 are set together between the upper and intermediate laminating rollers 221.

In this manner, the laminating machine 220 laminates the first sheet 10 and the second sheet 20 together, thereby forming the sheet member 30. Here, the first sheet 10 and the second sheet 20 are laminated together constantly at a preset certain lamination ratio by weight.

The cutting machine 230 has upper and lower cutting blades, and cuts the sheet member 30 by a predetermined length. Thus, the sheet member 30 becomes a predetermined-length original sheet for the interior part 1.

### Lamination Ratio by Weight of First Sheet and Second Sheet

In the first step S1, the recycle material 31 is contained in the first material 11 by a recycle ratio of r wt % (hereinafter, “wt” is omitted and simply referred to as “%”) to the first material 11. While the recycle ratio r differs by the type of the interior part 1 or the like, the recycle ratio r falls within a range of about 20% to 60% inclusive.

Here, when the content of the second material 21 to the sheet member 30 at the shipment of the shaped sheet member 30 as the interior part 1 is A%, that is, when the content of the second material 21 to the sheet member 30 after the first step S1 and the second step S2 are repeatedly performed infinitely often is A%, in the second step S2 of laminating the first sheet 10 and the second sheet 20 together, the second sheet 20 is set to have a ratio of [A·(100−r)]×10⁻⁴% to the sheet member 30.

In a general method for manufacturing the sheet member 30, firstly the lamination ratio by weight between the first sheet 10 and the second sheet 20 is set. Here, as the waste members 2 of the sheet member 30 are repeatedly recycled with the firstly determined lamination ratio by weight, the content A of the second material 21 gradually rises, and exceeds the predetermined content. Thus, the sheet member 30 whose physical property deviates from the designed physical property is manufactured.

For example, when the sheet member 30 is obtained as a lamination at a lamination ratio by weight of 90:10 between the first sheet 10 and the second sheet 20 with a recycle ratio r of 50%, theoretically, the ratio of the second material 21 rises to 20% after the first step S1 and the second step S2 are repeatedly performed infinitely often, doubling from the initial state.

When the physical property of the sheet member 30 deviates d poor values, the interior part 1 cannot be commercially provided. Conversely, when the physical property of the sheet member 30 deviates toward improving values, while the interior part 1 can be commercially provided, the improving values mean that the second material 21 is excessively used by the deviation, and the material cost is wasteful.

In view of the foregoing, in the method for manufacturing the sheet member 30 according to the embodiment, as described above, the initial lamination ratio by weight between the first sheet 10 and the second sheet 20 is reversely calculated from the final state and set.

By virtue of the lamination ratio by weight between the first sheet 10 and the second sheet 20 being set in this manner, the content of the second material 21 gradually rises toward the predetermined content. Thus, the sheet member 30 having the designed physical property is manufactured.

For example, when the content A of the second material 21 in the interior part 1 of the shipment quality is set to 15% with a recycle ratio r of 50%, theoretically, the first laminating for obtaining the sheet member 30 should be performed by a lamination ratio by weight of 92.5:7.5 between the first sheet 10 and the second sheet 20.

Then, a content Al of the second material 21 to the sheet member 30 after the first recycle is as follows:

A1=7.5+(7.5/100)×(92.5)×(50/100)=10.97%

A content A2 of the second material 21 to the sheet member 30 after the second recycle is as follows:

A2=7.5+(7.5/100)×(92.5)×(50/100)¹+(7.5/100)×(92.5)×(50/100)²=12.70%

A content An of the second material 21 to the sheet member 30 after the n-th recycle is as follows:

An=7.5+(7.5/100)×(50/100)¹×(92.5)+(7.5/100)×(50/100)²×(92.5)+ . . . +(7.5/100)×(50/100)ⁿ×(92.5)%

Here, when n is infinite ∞, a content A∞ of the second material 21 to the sheet member 30 is as follows:

A∞=7.5/[1−(50/100)]=15.00%

Note that, the values derived are as follows: A3=13.57%, A4=14.00%, A5=14.22%, A6=14.33%, A7=14.38%, A8=14.41%. The value of A6 being derived after the sixth recycle corresponds to about 96% of the value of A∞. Thereafter, since the content An of the second material 21 of the sheet member 30 asymptotically approaches 15.00%, the ultimate variation of the content is about 4%.

### Physical Property of Sheet M

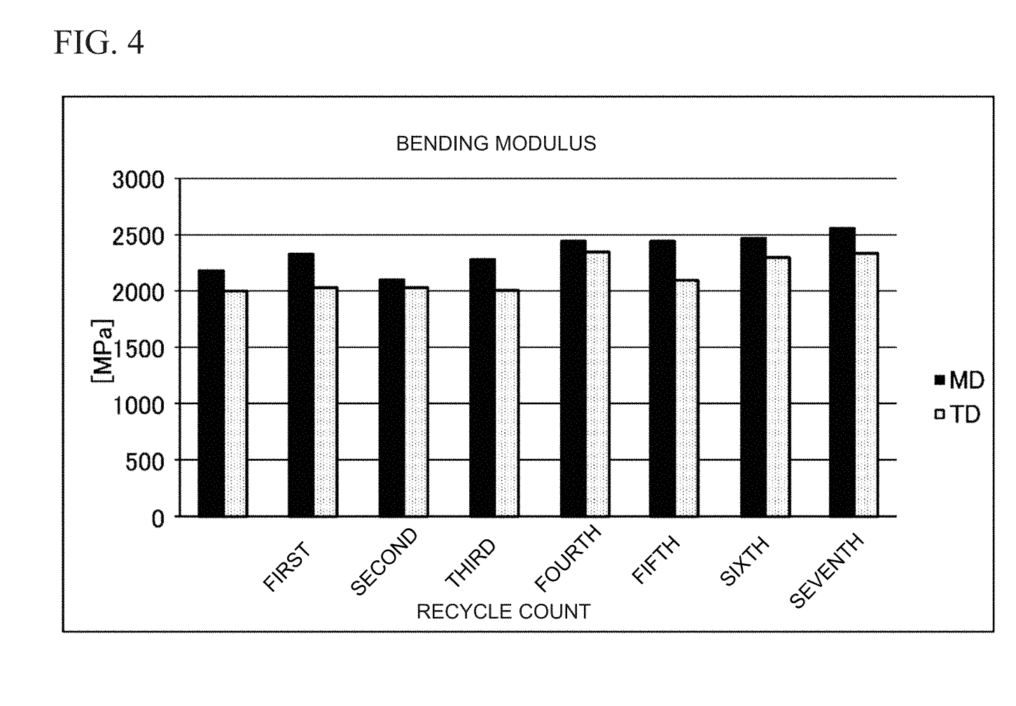

FIG. 4 is a graph showing the result of evaluating the physical property of the sheet member.

In order to evaluate the physical property of the sheet member 30, the bending test was performed as to the longitudinal direction (the extrusion direction, the machine direction (MD)) and the width direction (the transverse direction (TD)), and the bending modulus was obtained.

The test result demonstrates that the bending modulus of the sheet member 30 settles after around the sixth and seventh recycles, without a large difference between the sixth and seventh recycles. This can be explained as follows. As described above, after the sixth or seventh recycle, the content A6, A7 of the second material 21 to the sheet member 30 is about 96% of the value of A∞, where variations in the content of the second material 21 becomes small. Theoretically, the content A of the second material 21 to the sheet member 30 becomes about 96% of the value of A∞ after the fourth recycle.

On the other hand, for some reasons, the bending modulus in TD reduced after the fifth recycle. Accordingly, to be on the safe side, the interior part 1 made of the sheet member 30 after the sixth or seventh recycle should be commercially provided.

As has been described above, the method for manufacturing the sheet member 30 according to the first embodiment is a method for rnanufacturing a sheet member 30 being a lamination of a first sheet 10 and a second sheet 20. The method includes: a first step S1 of extruding, in a sheet-like manner, a first material 11 containing a sheet member 30 as a recycle material 31, to form a first sheet 10; and a second step S2 of laminating a second sheet 20 composed of a second material 21 and the first sheet 10 obtained by the extruding. In the first step S1, the recycle material 31 is mixed into the first material 11 by a recycle ratio of r wt % to the first material 11. When a content of the second material 21 to the sheet member 30 after the first step Si and the second step S2 are repeatedly performed infinitely often is A wt %, in the second step S2 of laminating the second sheet 20 and the first sheet 10, the second sheet 20 is set to have a ratio of [A·(100−r)]×10⁻⁴ wt % to the sheet member 30.

Thus, when the first sheet 10 is formed using the recycle material 31 being the waste members 2 of the sheet member 30 being a lamination of the first sheet 10 and the second sheet 20, the content A of the second material 21 to the sheet member 30 still assumes a predetermined value. Therefore, the sheet member 30 having the physical property true to design is manufactured.

Further, the recycling the waste members 2 of the sheet member 30 eliminates any waste object resulting from the manufacture of the interior part 1, Still further, the recycling the waste members 2 of the sheet member 30 also eliminates the necessity of removing or separating the first sheet 10 and the second sheet 20 from each other and, consequently, also eliminates any processes, apparatuses and manpower that would otherwise be required.

Subsequently, a description will be given of a second embodiment.

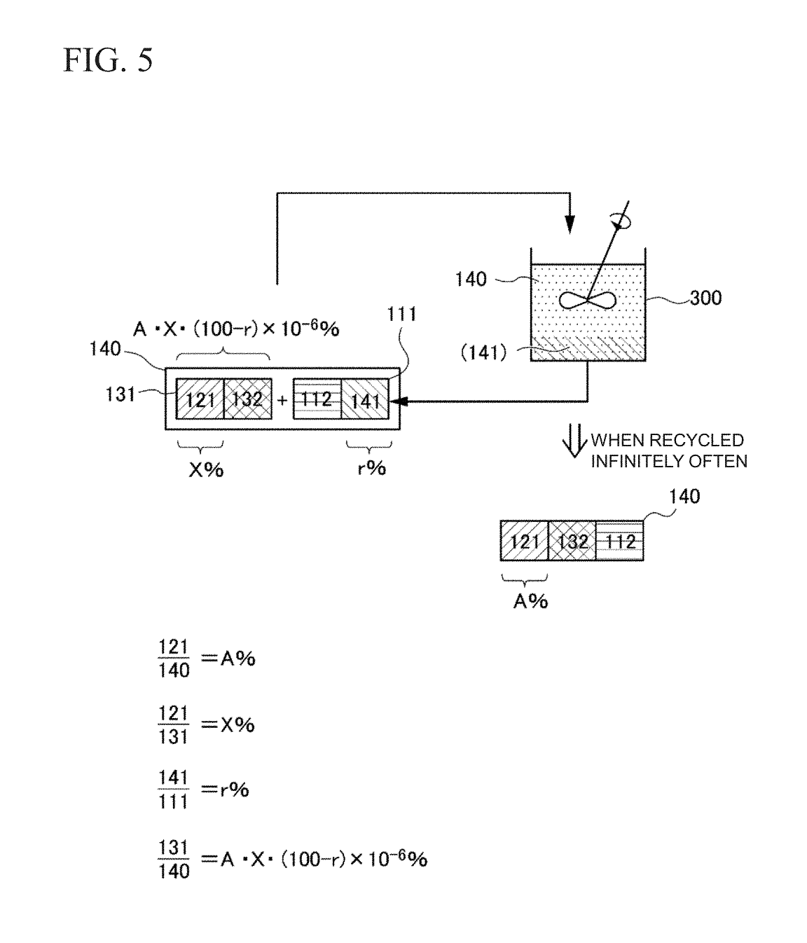

FIG. 5 is a schematic diagram illustrating a method for manufacturing a mixed material according to a second embodiment of the present invention.

In the first embodiment, the recycle technique is applied to the method for manufacturing a sheet member. On the other hand, in the second embodiment, the recycle technique is applied to a method for manufacturing a mixed material.

A mixed material 140 is manufactured by mixing a first material 111 and a third material 131 containing a second material 121 with each other using an agitating machine 300.

The first material. 111, the second material 121, and the third material 131 may each be a liquid or a powder. Alternatively, they may each be a solid which exhibits flowability by being melted, for example, the resin materials described in the first embodiment. Further, the type of the first material 111, the second material 121, and the third material 131 is not particularly limited, so long as they are evenly dispersed as, for example, a mixture of liquids, or a mixture of a liquid and a powder. For example, the first material 111, the second material 121, and the third material 131 may each be a liquid drug, a coating liquid, food, a composite resin or the like.

Note that, it is defined that the third material 131 also contains a third component 132, and contains the second material 121 being different from the third component 132. by X wt % (hereinafter “wt” is omitted, and simply referred to as “%”).

The mixed material 140 is supplied to production of any product after the mixing. The remainder of the mixed material 140 is again mixed with the first material 111 as a recycle material 141, by a recycle ratio of r% to the first material 111. While not particularly limited, the recycle ratio r may fall within a range of 5% to 60% inclusive. Note that, the remainder of the first material is defined as a first component 112.

Here, when the content of the second material 121 to the mixed material 140 in the supplying the mixed material 140 to production is A%, that is, when the content of the second material 121 after the recycling mixing is repeatedly performed infinitely often is A%, the third material 131 set to have a ratio of [A·X·(100−r)]×10⁻⁶% to the mixed material 140 is mixed into the first material 111.

For example, when the content A of the second material 121 in the mixed material 140 supplied to production is 20%; a recycle ratio r is 10%; and the content of the second material 121 in the third material 131 is 80%, theoretically, the first mixed material 140 should be obtained by laminating the first material 111 and the third material 131 at a ratio of 85.6:14.4,

As has been described above, the method for manufacturing the mixed material 140 according to the second embodiment is a method for manufacturing a mixed material 140 including a step of mixing a first material 111 and a third material 131 containing a second material 121 with each other. Into the first material 111, a mixed material 140 as a recycle material 141 is mixed by a recycle ratio of r wt % to the first material 111. When the content of the second material 121 is X wt %, and the content of the second material 121 to the mixed material 140 after the first material 111 and the third material 131 are mixed with each other infinitely often is A wt %, the third material 131 set to have a ratio of [A·X·(100−r)]×10⁻⁶ wt % to the mixed material 140 is mixed into the first material 111.

Thus, when the mixed material 140 being a mixture of the first material 111 and the third material 131 containing the second material 121 is supplied to production and a new mixed material 140 is prepared using the recycle material 141 being the remainder of the mixed material 140, the content of the second material 121 to the mixed material 140 still assumes a predetermined value. Thus, the mixed material 140 having the physical property true to design is manufactured.

### Variation

In the first embodiment, while the interior part 1 is manufactured using the sheet member 30, any other part may be manufactured using the sheet member 30. Further, the first sheet 10 may be a foamed sheet member. The second sheet 20 may be a woven fabric instead of a nonwoven fabric, or may be a sheet member or a film member.

The above-described mixing method according to the second embodiment may be applied to the mixing the extrusion material according to the first embodiment, to obtain a method for manufacturing the sheet member 30. In this case, the sheet member 30 is a lamination of the first sheet 10, and a second sheet 20 composed of a plurality of components.

Note that, the present invention is not limited to the above-described embodiments, and any modifications, improvements or the like within the scope of the object of the present invention are included in the present invention.

### REFERENCE SIGNS LIST

1: interior part

2: waste member

10: first sheet

11: first material

12: first component

13: additive (talc)

20: second sheet

21: second material

30: sheet member

31: recycle material

111: first material

112: first component

121: second material

131: third material

132: third component

140: mixed material

141: recycle material

200: manufacturing apparatus

210: extrusion machine

211: extrusion barrel

212: T-die

213: supply hopper

220: laminating machine

221: laminating roller

230: cutting machine

240: press forming machine

300: agitating machine

1-2. (canceled)

3. A method for manufacturing a sheet member, comprising:
mixing a recycle material by a recycle ratio of r wt % to a first material;
forming a first sheet by extruding the first material in a sheet-like manner; and
laminating a second sheet composed of a second material by a ratio of [A·(100−r)]×10⁻⁴ wt % to the sheet member, where A is a content of the second material to the sheet member by weight percent.

4. The method for manufacturing a sheet member according to claim 3, wherein
the recycle material is waste members of the sheet member.

5. A method for manufacturing a mixed material, comprising:
mixing a recycle material by a recycle ratio of r wt % to a first material;
mixing a second material by a ratio of X wt % to a third material; and
mixing the third material by a ratio of [A·X·(100−r)]×10⁻⁶ wt % to the first material, where A is a content of the second material to the mixed material by weight percent.

6. The method for manufacturing a mixed material according to claim 5, wherein
the recycle material is a remainder of the mixed material.
